(19) United States
(12) Patent Application Publication
(10) Pub. No.: US 2004/0012672 A1
(43) Pub. Date: Jan. 22, 2004

(54) Tube probing device

(75) Inventor: Takeshi Shiota, Kyoto-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Murata Kikai Kabushiki Kaisha, Kyoto-shi (JP)

(21) Appl. No.: 10/615,791

(22) Filed: Jul. 10, 2003

(30) Foreign Application Priority Data
Jul. 16, 2002 (JP) 2002-206682

(51) Int. Cl. H04N 7/18; H04N 9/47

(52) U.S. Cl. 348/84

(57) ABSTRACT

The present invention provides a cylindrical tube probing device (P) having a casing with a camera and wheel members disposed on the casing. When a spacing between the wheel members disposed at respective sides of the casing is enlarged, support frames (4A), (4B) which are disposed on said casing and on which the respective wheel members are disposed are moved in a vertical direction in unison with the enlarging or contracting motion. A center of a lens (2a) disposed in the camera is located at a center (t2),(t3) of a cylindrical tube (T1), (T2). Therefore, the tube probing device can be placed in a tube of an arbitrary diameter buried in the ground without the need to increase the distance the wheel members are moved for enlargement or contraction.

### FIELD OF THE INVENTION

The present invention relates to a self-running tube probing device that uses a camera with a fish-eye lens to probe internally a tube for flaws or the like.

### BACKGROUND OF THE INVENTION

Conventional self-running probing devices are known which are configured to probe tubes of different inner diameters by changing the distance between wheels disposed at the respective sides of a casing main body, depending on the inner diameter of a tube to be probed (for example, the Unexamined Japanese Patent Application Publication (Tokkai-Hei) No. 11-64230). Such a tube probing device is configured so that a fish-eye lens of a camera disposed at a tip of the casing main body is always centered at the center of the tube.

FIG. 8 schematically shows a tube probing device (P′) placed in a tube (T1) of a smaller inner diameter. The center of a fish-eye lens (p1) of a camera of the tube probing device (P′) is located at the center (t1′) of the tube (T1). Wheels (p3) disposed at the respective sides of a telescopic axle (p2) are placed on the inner surface of the tube (T1). (p4) is a floodlight disposed around the periphery of the fish-eye lens (p1). As shown in FIG. 9, if the tube probing device (P′) is placed in a tube (T2) of a larger inner diameter, the telescopic axle (p2) is extended until the wheels (p3) are placed on the inner surface of the tube (T2) of the larger inner diameter.

As described above, the axle (p2) is extended or contracted in order to change only the distance between the wheels (p3), disposed at the respective ends of the tube probing device (P′). However, a reduction gear and the like are disposed between the wheels (p3). Accordingly, the amount of extension and contraction of the axle (p2) is limited. Therefore, there is disadvantageously a limit on the size of the tube in which the tube probing device (P′) is placed.

Further, the strength and rigidity of the axle (p2) and others must be increased in order to extend the axle (p2) further. Therefore, the tube probing device (P′) must be larger and more complicated.

It is an object of the present invention to solve the above described problems with the conventional tube probing device.

### SUMMARY OF THE INVENTION

To achieve the above object, the present invention provides a cylindrical tube probing device having a casing with a camera and wheel members disposed on the casing, the device being characterized as described below. First, when a spacing between the wheel members disposed at respective sides of the casing is enlarged, support frames which are disposed on the casing and on which the respective wheel members are disposed are moved in a vertical direction in unison with the enlarging or contracting motion, and a center of a lens disposed in the camera is located at a center of a cylindrical tube. Second, the support frames on which the respective wheel members are disposed are each connected to the casing via hinge members. Third, the casing and an enlarging and contracting member that enlarges or contracts the spacing between the wheel members are connected together via a side run-out preventing member.

### BRIEF DESCRIPTION OF THE DRAWINGS

FIG. 1 is a perspective view of tube probing device according to the present invention, including a partial exploded view.

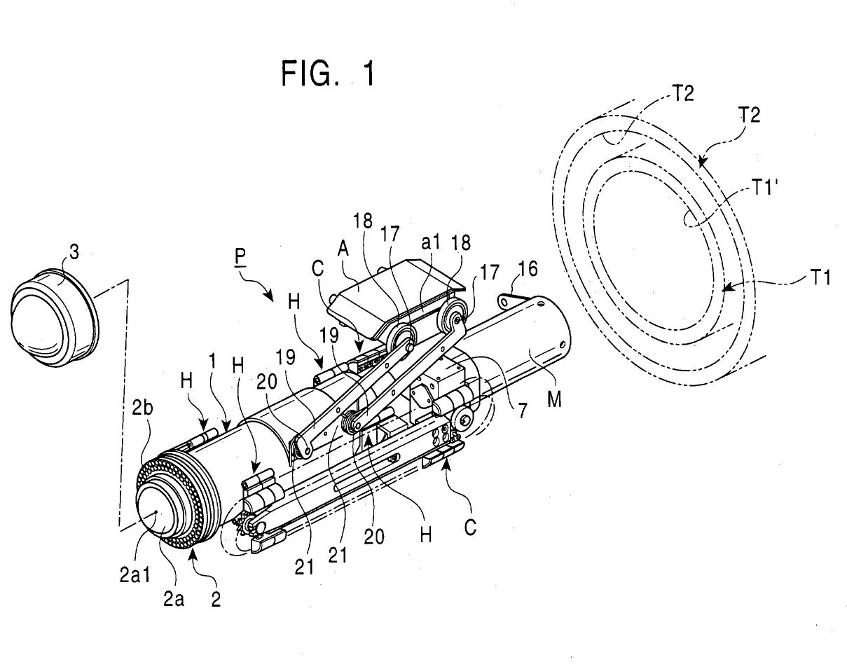

FIG. 2 is a perspective view of a lower part of the tube probing device according to the present invention.

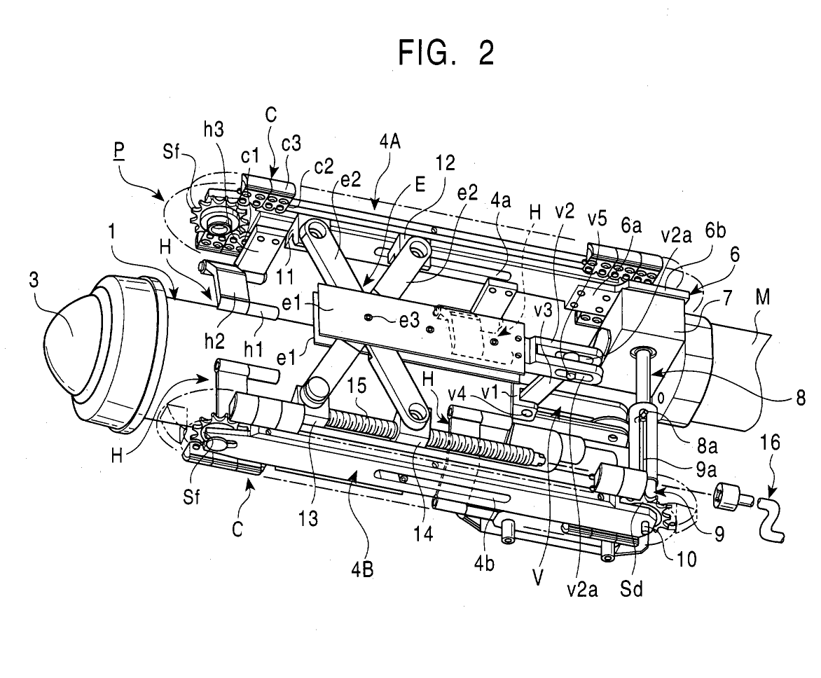

FIG. 3 is a bottom view of the tube probing device according to the present invention.

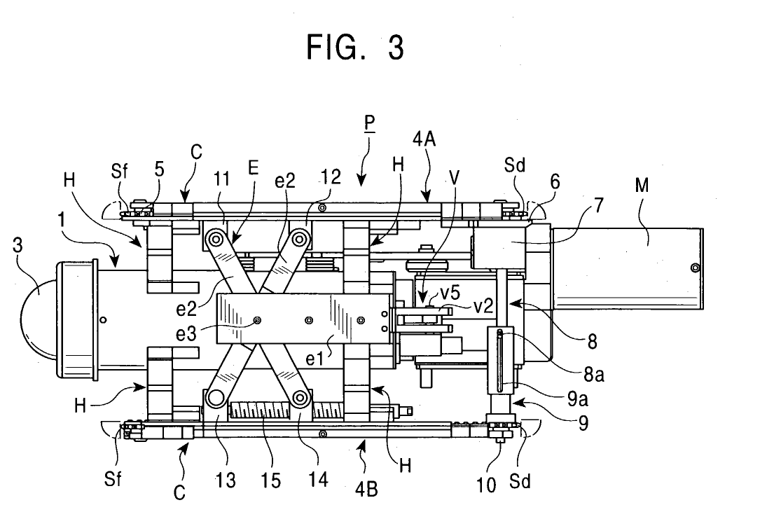

FIG. 4 is a partial perspective view of the tube probing device according to the present invention.

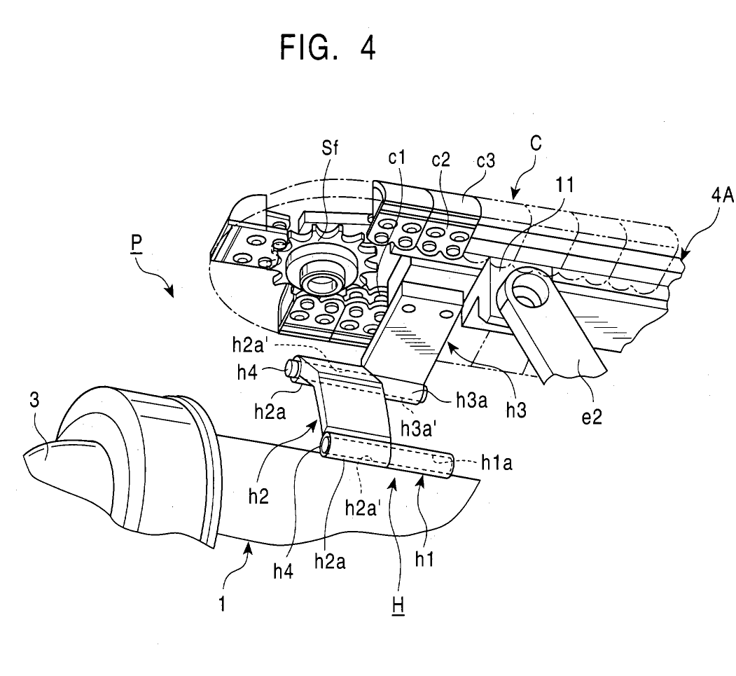

FIG. 5 is a front view showing that the tube probing device according to the present invention has been placed in a tube of a larger inner diameter.

FIG. 6 is a front view showing that the tube probing device according to the present invention has been placed in a tube of a smaller inner diameter.

FIG. 7 is a schematic view illustrating the principle of the tube probing device according to the present invention.

FIG. 8 is a front view showing that a conventional tube probing device has been placed in a tube of a larger inner diameter.

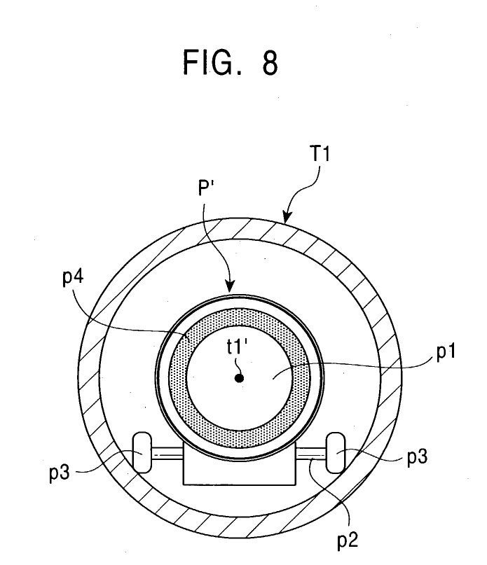

FIG. 9 is a front view showing that the conventional tube probing device has been placed in a tube of a smaller inner diameter.

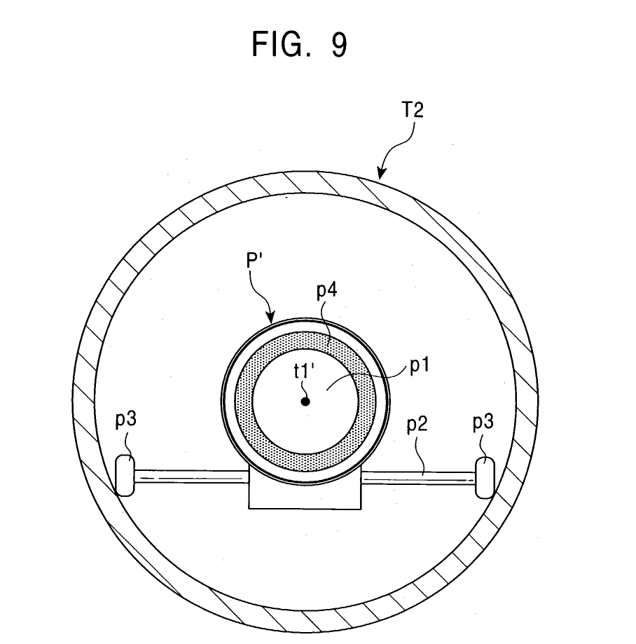

### DETAILED DESCRIPTION OF THE PREFERRED EMBODIMENTS

An embodiment of the present invention will be described below. However, the present invention is not limited to the present embodiment. Other embodiments are possible unless they depart from the spirits of the present invention.

(1) is a generally cylindrical casing, and (2) is a camera disposed at the tip of the casing (1). (2a) is a fish-eye lens of the camera (2) around which a plurality of illuminating lamps (2b) are disposed. (3) is a cover that covers the fish-eye lens (2a) and the illuminating lamps (2b). For the convenience of description, the side on which the camera (2) is disposed is referred to as the front of the casing (1). The opposite side is referred to as the rear of the casing (1).

(H) is one of four hinge members disposed at two points in the front bottom of the casing (1) and at two points in its rear bottom. The hinge member (H) has a fixed cylinder (h1) attached to the bottom of the casing (1) so that a shaft hole (h1a) extends along a longitudinal direction of the casing (1), an intermediate block (h2) having cylinders (h2a) attached to its respective ends, the cylinders (h2a) each having a shaft hole (h2a′), and a fixed block (h3) having a cylinder (h3a) attached to one end, the cylinder (h3a) having a shaft hole (h3a′). A horizontally long support frame (4A) is attached, by appropriate securing means such as bolts and nuts or welding, to the fixed block (h3) of one of the hinge members (H) arranged in the front bottom of the casing (1) and to the fixed block (h3) of one of the hinge members (H) arranged in the rear bottom of the casing (1), and extends along the longitudinal direction of the casing (1). Further, a horizontally long support frame (4B) is attached, by appropriate securing means such as bolts and buts or welding, to the fixed block (h3) of the other hinge member (H) arranged in the front bottom of the casing (1) and to the fixed block (h3) of the other hinge member (H) arranged in the rear bottom of the casing (1), and extends along the longitudinal direction of the casing (1).

By fitting shaft pins (h4) into the shaft hole (h1a) in the fixed cylinder (h1) attached to the bottom of the casing (1) and into the shaft hole (h2a′) in the cylinder (h2a) attached to one end of the intermediate block (h2), the fixed cylinder (h1) and the intermediate block (h2) are connected together so that the intermediate block (h2) can be rotatively moved with respect to the fixed cylinder (h1). Further, by fitting shaft pins (h4) into the shaft hole (h2a′) in the cylinder (h2a) attached to the other end of the intermediate block (h2) and into the shaft hole (h3a′) in the fixed block (h3) attached to support frame (4A) or support frame (4B), the fixed block (h3) and the intermediate block (h2) are connected together so that the intermediate block (h2) can be rotatively moved with respect to the fixed block (h3). In this manner, the casing (1) and the support frames (4A),(4B) are connected together by the four hinge members (H) each composed of the fixed cylinder (h1), the intermediate block (h2), the fixed block (h3) and the shaft pins (h4). The shaft pin (h4) supporting pivotally the fixed cylinder (h1) and the intermediate block (h2) is located below the shaft pin (h4) supporting pivotally the fixed block (h3) and the intermediate block (h2).

A short shaft (5) is attached to the inner surface of the front (the front side of the casing (1)) of each of the pair of support frames (4A),(4B) disposed opposite each other along the longitudinal direction of the casing (1). A follower sprocket (Sf) is rotatably disposed over the short shaft (5) via an appropriate bearing. Further, a plate-like sub-support frame (6) is disposed on the inner surface of the rear (the rear side of the casing (1)) of the support frame (4A), with the front (the front side of the casing (1)) of the sub-support frame (6) attached to the support frame (4A). An appropriate gap is formed between a rear portion (6b) of the sub-support frame (6) and the support frame (4A). A reduction box (7) containing a reduction gear is attached to the rear portion (6b) of the sub-support frame (6a) on a side of the support frame (4B). A drive motor (M) is attached to the reduction box (7). One end of an output shaft (8) of the reduction gear is supported on the support frame (4A) via an appropriate bearing. A driving sprocket (Sd) is attached to the output shaft (8), located in the gap formed between the support frame (4A) and the rear portion (6b) of the frame (6).

(9) is a generally cylindrical drive transmitting cylindrical member into which the output shaft (8) can be telescopically inserted. The drive transmitting cylindrical member (9) has a slit (9a) formed in its axial direction. A short shaft (10) is attached to the tip of the drive transmitting cylindrical member (9) and penetrates the support frame (4B) and is supported on it via a proper bearing. The driving sprocket (Sd) is attached to the short shaft (10). A drive transmitting pin (8a) attached to the tip of the output shaft (8) is inserted into the slit (9a) in the drive transmitting cylindrical member (9) and is used to prevent the output shaft (8) from slipping out and to transmit driving. Accordingly, the output shaft (8) can be prevented from slipping out of the slit (9a) in the drive transmitting cylindrical member (9). Further, when the drive motor (M) is driven to rotate the output shaft (8) of the reduction gear, rotation of the output shaft (8) is transmitted to the drive transmitting cylindrical member (9).

An endless chain (c1) is extended between the follower sprocket (Sf) and the driving sprocket (Sd) disposed on the support frame (4A). Tire blocks (c3) formed of rubber or a synthetic resin are attached to respective chain blocks (c2) attached to the endless chain (c1). A caterpillar (C) as a wheel member is constituted by the follower sprocket (Sf), the driving sprocket (Sd), the endless chain (c1), the chain blocks (c2) and the tire blocks (c3). In place of the caterpillars (C) as wheel members which are disposed on the support frames (4A),(4B), respectively, wheels with tires may be attached to the support frames (4A),(4B), respectively.

(E) is an enlarging and contracting member having two plate materials (e1) arranged at an appropriate spacing between them and coupled together by appropriate means such as bolts and nuts or the like. (e2) is one of a pair of enlarging and contracting rods, the center of which is pivotally supported by a short shaft (e3) attached between the two plate materials e1 and arranged so as to cross each other in X-form.

A sliding groove (4a) is formed between the follower sprocket (Sf) and the driving sprocket (Sd) of one (4A) of the opposite support frames (4A),(4B) and along the longitudinal direction of the support frame (4A). A fixed block (11) is attached to the support frame (4A) between the follower sprocket (Sf) and the sliding groove (4a). Further, a sliding block (12) is attached to the sliding groove (4a) so as to be slidable along the sliding groove (4a).

A sliding groove (4b) is formed between the follower sprocket (Sf) and the driving sprocket (Sd) of the other (4B) of the opposite support frames (4A),(4B) and along the longitudinal direction of the support frame (4B). A fixed block (13) is attached to the support frame (4B) between the follower sprocket (Sf) and the sliding groove (4a). Further, a threaded sliding block (14) with a threaded groove hole is attached to the sliding groove (4b) so as to be slidable along the sliding groove (4b). (15) is a feeding screw rod, the tip of which is rotatably pivotally supported on the fixed block (13). Further, the threaded groove hole formed in the threaded sliding block (14) is screwed over the feeding screw rod (15).

One of the pair of enlarging and contracting rods (e2), arranged so as to cross each other in X-form, has one end supported pivotally on the fixed block (11), attached to the support frame (4A). Further, the other end of this enlarging and contracting rod (e2) is pivotally supported on the threaded sliding block (14), screwed over the feeding screw rod (15), disposed on the support frame (4B). Similarly, the other of the pair of enlarging and contracting rods (e2), arranged so as to cross each other in X-form, has one end supported pivotally on the fixed block (13), attached to the support frame (4B). Further, the other end of this enlarging and contracting rod (e2) is pivotally supported on the sliding block (12), disposed on the support frame (4A).

A crank handle (16) is attached to an end of the feeding screw rod (15). When the feeding screw rod (15) is rotated, the threaded sliding block (14) is moved along the feeding screw rod (15). Then, the pair of enlarging and contracting rods (e2), the center of which is supported pivotally by the short shaft (e3), the rods (e2) being arranged so as to cross each other in X-form, is rotatively moved so that the rods (e2) approach or leave each other. Then, when the feeding screw rod (15) is rotated to move the threaded sliding block (14) toward the fixed block (13), the threaded sliding block (14) being screwed over the feeding screw rod (15) disposed on the fixed block (13), then the sliding block (12), disposed on the support frame (4A), is also moved toward the fixed block 11. Accordingly, the pair of caterpillars (C), disposed at the tips of the corresponding enlarging and contracting rods (e2), is moved away from the casing (1). Thus, the spacing between the caterpillars (C) is enlarged. On the other hand, when the feeding screw rod (15) is rotated to move the threaded sliding block (14) away from the fixed block (13), the threaded sliding block (14) being screwed over the feeding screw rod (15) disposed on the fixed block (13), then the sliding block (12), disposed on the support frame (4A), is moved away from the fixed block (11). Accordingly, the pair of caterpillars (C), disposed at the tips of the corresponding enlarging and contracting rods (e2), is moved toward the casing (1). Thus, the spacing between the caterpillars (C) is narrowed. In this manner, the spacing between the pair of caterpillars (C) can be properly adjusted.

As described above, when the spacing between the pair of caterpillars (C) is enlarged or narrowed, the output shaft (8), inserted telescopically into the generally cylindrical drive transmitting cylindrical member (9), moves freely through the generally cylindrical drive transmitting cylindrical member (9). Accordingly, the spacing between the pair of caterpillars (C) can be freely enlarged or narrowed.

(V) is a side run-out preventing member for the enlarging and contracting member (E). The side run-out preventing member (V) has a casing side bracket (v1) attached to that end surface of the casing (1) which is located opposite the camera (2), the casing side bracket (v1) being generally U-shaped in a plan view, an enlarging and contracting member side bracket (v2) having one end sandwiched between rear portions (the rear side of the casing (1)) of the two plate materials (e1) and attached to the rear portions, the plate materials (e1) constituting the enlarging and contracting member (E), the enlarging and contracting member side bracket (v2) being also generally U-shaped in a plan view, and a connection rod (v3) connecting the casing side bracket (v1) and the enlarging and contracting member side bracket (v2) together. One end of the connection rod (v3) is pivotally supported on the casing side bracket (v1) by a pivotal pin (v4). Further, a horizontally long groove (v2a) is formed in each of the opposite arms of the enlarging and contracting side bracket (v2). Each end of a pin (v5) attached to the other end of the connection rod (v3) is inserted into the horizontally long groove (v2a) so that the pin (v5) can be moved along the horizontally long groove (v2a).

(A) is a radar antenna used to probe a cavity located above a tube buried in the ground. A pair of horizontal shaft pins (17) is attached to a main body (a1) of the radar antenna (A) so that the pins (17) are arranged with a predetermined spacing between them. A guide wheel (18) is disposed over each of the horizontal shaft pins (17). One end of a pivoting arm (19) is pivotally supported on the tip of each horizontal shaft pin (17). Further, a pair of horizontal shaft pins (20) is attached to the casing (1) so that the pins (20) are arranged with a predetermined spacing between them. The other end of the pivoting arm (19) is pivotally supported on the horizontal shaft pin (20), with a coil spring (21) installed on the horizontal shaft pin (20). Further, one end of the coil spring (21) is locked on the casing (1), while the other end is locked on the pivoting arm (19). The resilient force of the coil spring (21) urges the pair of pivoting arms (19) to move rotatively upward around the horizontal shaft pin (20), attached to the casing (1).

Now, a description will be given of how the tube probing device (P) configured as described above and the enlarging and contracting member (T) and others are operated when the tube probing device (P) is placed in a tube (T1) of a smaller inner diameter or a tube (T2) of a larger inner diameter.

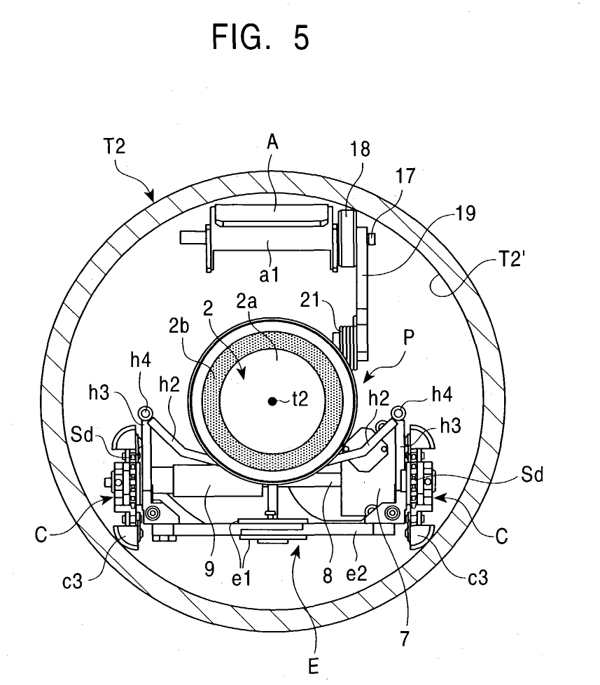

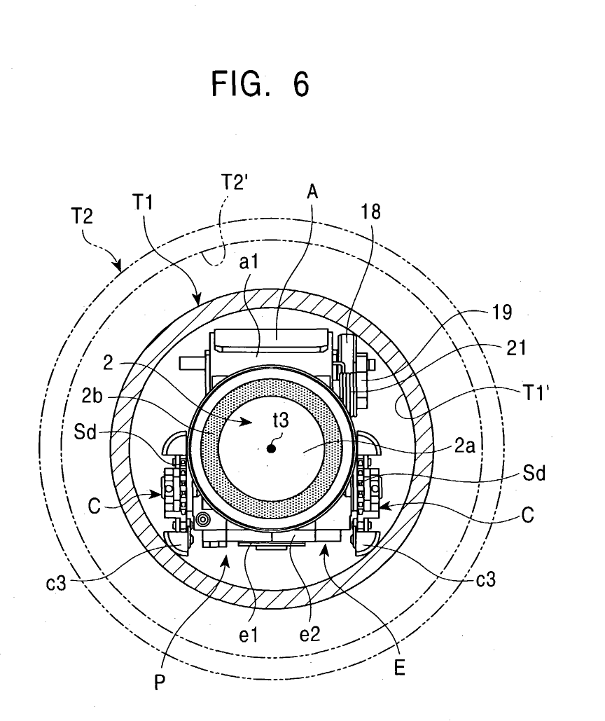

As shown in FIGS. 5 and 6, when the tube probing device (P) is placed in the tube (T1) of the smaller inner diameter or the tube (T2) of the larger inner diameter buried in the ground, the caterpillars (C) are abutted against and placed on an inner surface (T1′) of the tube (T1) of the smaller inner diameter or an inner surface (T2′) of the tube (T2) of the larger inner diameter. Further, the guide wheels (18), disposed at the upper ends of the respective pivoting arms (19), urged by the resilient force to move rotatively upward, abut against the inner surface (T1′) of the tube (T1) of the smaller inner diameter or the inner surface (T2′) of the tube (T2) of the larger inner diameter. At this time, the radar antenna (A) does not abut against the inner surface (T1′) of the tube (T1) of the smaller inner diameter or the inner surface (T2′) of the tube (T2) of the larger inner diameter.

When the tube probing device (P) is placed in the tube (T1) or (T2) buried in the ground, the crank handle (16) is attached to the end of the feeding screw rod (15) to rotate the feeding screw rod (15). Thus, the spacing between the pair of caterpillars (C) is properly adjusted so that the caterpillars (C) are abutted against and placed on the inner surface (T1′) of the tube (T1) of the smaller inner diameter or the inner surface (T2′) of the tube (T2) of the larger inner diameter.

For example, if the tube probing device (P) is placed in the tube (T2) of the larger inner diameter as shown in FIG. 5, the feeding screw rod (15) is rotated to enlarge the spacing between the pair of caterpillars (C) so as to abut and place the pair of caterpillars (C) against and on the inner surface (T2′) of the tube (T2) of the larger inner diameter. In this condition, the center (2a1) of the fish-eye lens (2a) of the camera (2) coincides with the center (t2) of the tube (T2) of the larger inner diameter. In this condition, the drive motor (M) for the tube probing device (P) is driven to move peripherally the caterpillars (C). Then, the tube probing device (P) moves through the tube (T2) of the larger inner diameter to probe it.

Then, the tube probing device (P) placed in the tube (T2) of the larger inner diameter shown in FIG. 5 is placed in the tube (T1) of the smaller inner diameter as shown in FIG. 6. In this case, as described above, the crank handle (16) is attached to the end of the feeding screw rod (15) to rotate the feeding screw rod (15). Thus, the threaded sliding block (14), screwed over the feeding screw rod (15), disposed on the support frame (4B), is separated from the fixed block (13). Further, the sliding block (12), disposed on the support frame (4A), is separated from the fixed block (11) to narrow the spacing between the pair of caterpillars (C). Then, the intermediate block (h2), constituting the hinge member (H), is moved downward around the shaft pin (h4) toward the fixed block (h3). When the intermediate block (h2), constituting the hinge member (H), is thus moved downward around the shaft pin (h4) toward the fixed block (h3), the casing (1), coupled to the hinge member (H), is moved downward via the cylinder (h2a) of the intermediate block (h2), the shaft pin (h4), and the fixed cylinder (h1).

When the feeding screw rod (15) is rotated to abut and place the pair of caterpillars (C) against and on the inner surface (T1′) of the tube (T1) of the smaller inner diameter as described above, the intermediate block (h2), constituting the hinge member (11), is moved downward around the shaft pin (h4) toward the fixed block (h3). Further, the casing (1), coupled to the hinge member (H), is moved downward until the center (2a1) of the fish-eye lens (2a) of the camera (2) coincides with the center (t3) of the tube (T1) of the smaller inner diameter.

Further, as described above, when the pair of caterpillars (C) is moved so that the spacing between the caterpillars (C) is enlarged or narrowed, the intermediate block (h2), constituting the hinge member (H), is moved toward or away from the fixed block (h3) around the shaft pin (h4) to move vertically the casing (1), coupled to the hinge member (H). In this respect, as described above, the casing (1), and the enlarging and contracting member (E) are connected together via the side run-out preventing member (V). Further, the pin (v5) attached to the end of the connection rod (v3), constituting the side run-out preventing member (V), is inserted into the horizontally long grooves (v2a) so as to be movable along the horizontally long groove (v2a), formed in the respective opposite arms of the enlarging and contracting member side bracket (v2). Accordingly, when the casing (1) is moved in the vertical direction, the connection rod (v3), constituting the side run-out preventing member (V), moves around the pin pivotal shaft (v4), attached to the casing side bracket (v1). Further, the pin (v5), attached to the end of the connection rod (v3), moves along the horizontally long groove (v2a), formed in the respective opposite arms of the enlarging and contracting member side bracket (v2). Consequently, the side run-out preventing member (V) does not hinder a variation in the spacing between the casing (1) and the enlarging and contracting member (E).

Further, since the casing (1), and the enlarging and contracting member (E) are connected together by the side run-out preventing member (V), the enlarging and contracting member (E) is not moved in the horizontal direction while the spacing between the pair of caterpillars (C) is being adjusted. The distance one of the caterpillars (C) moves away from the central axis of the casing (1) is prevented from differing from the distance the other caterpillar (C) moves away from the central axis of the casing (1). The caterpillars (C), constituting the pair, move uniformly. Accordingly, when the spacing between the pair of caterpillars (C) is enlarged or narrowed, the caterpillars (C) move uniformly relative to the central axis of the casing (1). This prevents the center (2a1) of the fish-eye lens (2a) of the camera (2) from being misaligned with respect to the centers (t2),(t3) of the tubes (T1),(T2), respectively.

As described above, when the spacing between the wheel members such as the caterpillars (C), disposed on the casing (1), having the camera (2), is enlarged or narrowed, the support frames (4A),(4B), which are disposed on the casing (1) and on which the respective wheel members are disposed, are moved up or down with respect to the casing (1). Consequently, the tube probing device (P) can be placed in a tube of an arbitrary diameter buried in the ground without the need to increase the distance the wheel members are moved for enlargement or contraction.

Further, since the tube probing device (P) can be placed in a tube of an arbitrary diameter buried in the ground without the need to increase the distance the wheel members are moved for enlargement or contraction, the strength or rigidity of the axle (p2) and others need not be increased compared to the conventional tube probing device (P′), which requires the wheel members to be moved a larger distance for enlargement or contraction. This eliminates the need to make the tube probing device (P) larger or more complicated.

Furthermore, the support frames (4A),(4B), on which the respective wheel members are disposed, are connected to the casing (1) via the hinge member (H). This simple configuration allows the support frames (4A),(4B) to move up or down with respect to the casing (1). It is thus possible to miniaturize and simplify the tube probing device (P) and reduce the need for maintenance.

Moreover, the casing (1), and the enlarging and contracting member (E) are connected together by the side run-out preventing member (V). Accordingly, the enlarging and contracting member (E) is not moved in the horizontal direction while the spacing between the pair of caterpillars (C) is being adjusted. The caterpillars (C), constituting the pair, can move uniformly with respect to the central axis of the casing (1). This prevents the center (2a1) of the fish-eye lens (2a) of the camera (2) from being misaligned with respect to the centers (t2),(t3) of the tubes (T1),(T2), respectively.

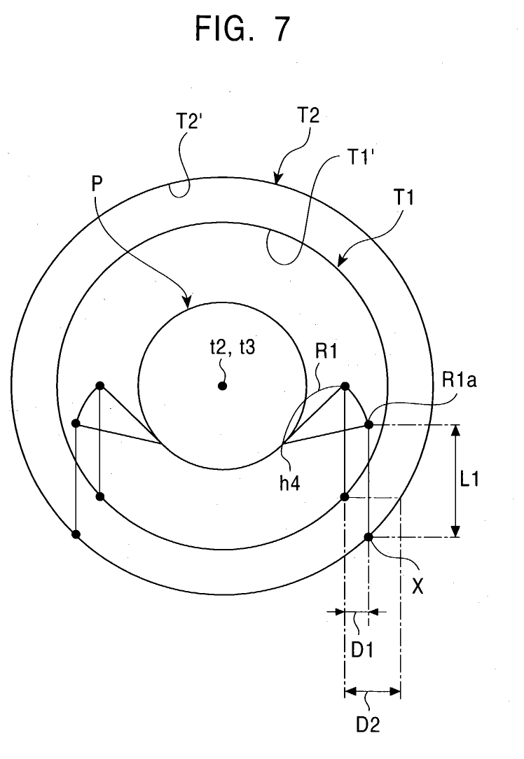

As described above, with the tube probing device (P) of the present invention, when the distance between the caterpillars (C) as wheel members is increased so that the caterpillars (C), installed on the inner surface (T1′) of the tube (T1) of the smaller inner diameter, is abutted against and placed on the inner surface (T2′) of the tube (T2) of the larger inner diameter, the support frames (4A),(4B), on which the respective caterpillars (C) are disposed, are moved up or down in unison with an enlarging or contracting motion of the caterpillars (C). Accordingly, simply by increasing the distance between the caterpillars (C) by a value (D1) as shown in FIG. 7, the caterpillars (C) can be abutted against and placed on the inner surface (T2′) of the tube (T2) of the larger inner diameter. Furthermore, in order to prevent the center (2a1) of the fish-eye lens (2a) of the camera (2) from being misaligned with respect to the center (t3) of the tube (T1) of the smaller inner diameter or the center (t2) of the tube (T2) of the larger inner diameter, the length of the intermediate block (h2) and the position of the shaft pin (h4) as a rotative-movement support point for the intermediate block (h2) are properly set so that the caterpillars (C) are abutted against and placed at the intersection (X) between the inner surface (t2′) of the tube (T2) of the larger inner diameter and a line extending, by the length (L1) of the support frames (4A),(4B), vertically from a circular point (R1a) of a rotative-movement radius (R1) of the intermediate block (h2), which rotatively moves around the shaft pin (h4). With this arrangement, even with a variation in the spacing between the opposite caterpillars (C), the center (2a1) of the fish-eye lens (2a) of the camera (2) can be located at the center of various tubes of different inner diameters.

With the arrangements described above, the present invention produces the effects described below.

When the distance between the wheel members disposed on the casing is increased, the support frames, which is disposed on the casing and on which the respective wheel members are disposed, are moved up or down in unison with an enlarging or contracting motion of the wheel members. Accordingly, the tube probing device can be placed in a tube of an arbitrary diameter buried in the ground without the need to increase the distance the wheel members are moved for enlargement or contraction.

Further, since the tube probing device can be placed in a tube of an arbitrary diameter buried in the ground without the need to increase the distance the wheel members are moved for enlargement or contraction, the strength or rigidity of the axle and others need not be increased compared to the conventional tube probing device, which requires the wheel members to be moved a larger distance for enlargement or contraction. This eliminates the need to make the tube probing device larger or more complicated.

Furthermore, the support frames, on which the respective wheel members are disposed, are connected to the casing via the hinge member. This simple configuration allows the support frames to move up or down with respect to the casing. It is thus possible to miniaturize and simplify the tube probing device and reduce the need for maintenance.

Moreover, the casing and the enlarging and contracting member for enlarging or narrowing the spacing between the wheel members are connected together by the side run-out preventing member. Accordingly, the enlarging and contracting member is not moved in the horizontal direction while the spacing between the pair of caterpillars is being adjusted. The wheel members can move uniformly with respect to the central axis of the casing. This prevents the center of the fish-eye lens of the camera from being misaligned with respect to the center or the tube.

1. A cylindrical tube probing device having a casing with a camera and wheel members disposed on the casing, the device being characterized in that when a spacing between the wheel members disposed at respective sides of said casing is enlarged, support frames which are disposed on said casing and on which the respective wheel members are disposed are moved in a vertical direction in unison with said enlarging or contracting motion, and a center of a lens disposed in said camera is located at a center of a cylindrical tube.

2. A tube probing device according to claim 1, characterized in that the support frames on which the respective wheel members are disposed are each connected to the casing via hinge members.

3. A tube probing device according to claim 1 or claim 2, characterized in that the casing and an enlarging and contracting member that enlarges or contracts the spacing between the wheel members are connected together via a side run-out preventing member.

4. A tube probing device according to any one of claims 1˜3, characterized in that said wheel members are each configured as a caterpillar comprising an endless chain extended between a driving sprocket and a follower sprocket both disposed on one of the support frames or between a driving sprocket and a follower sprocket both disposed on the other support frame, and tire blocks attached to the endless chain and made of rubber or a synthetic resin.
